(19) United States
(12) Patent Application Publication
(10) Pub. No.: US 2003/0046111 A1
(43) Pub. Date: Mar. 6, 2003

(54) System and method for treating pelvic floor disorders

(75) Inventor: Eva S. Snitkin, Minneapolis, MN (US)

Correspondence Address: Attention: Jeffrey J. Hohenshell, AMS Research Corporation, 10700 Bren Road West, Minnetonka, MN, 55343, US

(73) Assignee: American Medical Systems

(21) Appl. No.: 10/233,347

(22) Filed: Aug. 30, 2002

Related U.S. Application Data
(60) Provisional application No. 60/316,553, filed on Aug. 31, 2001.

(51) Int. Cl. G06F 17/60

(52) U.S. Cl. 705/2

(57) ABSTRACT

The present invention discloses methods and systems useful in sorting, tracking and reporting information, for example, information relating to sling procedures for treating incontinence.

### CROSS REFERENCE TO RELATED APPLICATION

The present application claims priority to U.S. Provisional Application Serial No. 60/316,553, filed Aug. 31, 2001.

### BACKGROUND

Over 13 million American men and women of all ages suffer from urinary incontinence. The social implications for an incontinent patient include loss of self-esteem, embarrassment, restriction of social and sexual activities, isolation, depression and, in some instances, dependence on caregivers. Incontinence is the most common reason for institutionalization of the elderly.

Incontinence may occur when the muscles of the urinary system malfunction or are weakened. There are five basic types of incontinence: stress incontinence, urge incontinence, mixed incontinence, overflow incontinence and functional incontinence. Stress urinary incontinence (SUI) is the involuntary loss of urine that occurs due to sudden increases in intra-abdominal pressure resulting from activities such as coughing, sneezing, lifting, straining, exercise and, in severe cases, even simply changing body position. Urge incontinence, also termed “hyperactive bladder” “frequency/urgency syndrome” or “irritable bladder,” occurs when an individual experiences the immediate need to urinate and loses bladder control before reaching the toilet. Mixed incontinence is the most common form of urinary incontinence. Mixed incontinence is a combination of the symptoms for both stress and urge incontinence. Overflow incontinence is a constant dripping or leakage of urine caused by an overfilled bladder. Functional incontinence is generally caused by factors outside the lower urinary tract, such as deficits in physical function and/or cognitive function.

There is a general lack of consensus concerning appropriate treatments for incontinence. The literature reports over 100 different surgical procedures for the treatment of stress incontinence. See Fisher-Rasmussen, Treatment of Stress Urinary Incontinence, Annals of Medicine, 22:455-65 (1990). The sheer number of surgical procedures advocated for SUI reflects the lack of success for many of the techniques, including the lack of consistent, repeatable success. The number also reflects disjointed efforts made to develop new techniques or to standardize existing techniques. Many of the techniques have not been objectively evaluated. See S. L. Stanton, Urethral Sphincter Incompetence (Stress Incontinence), Chapter 22 of Urodynamics, Principles, Practice and Application, (Churchill Livingstone 1984), pp.'s 229-241. Examples of incontinence procedures are disclosed in U.S. Pat. Nos. 5,112,344; 5,611,515; 5,842,478; 5,860,425; 5,899,909; 6,039,686, 6,042,534 and 6,110,101.

Surgical procedures include sling procedures, colposuspension procedures, and needle suspension procedures. Colposuspension procedures seek to place the urethra in high retropubic position. The Marshall-Marchetti-Krantz procedure and the Burch procedure are examples of colposuspension procedures. The Marshall-Marchetti-Krantz procedure places sutures at the urethrovesical junction to the periosteum of the pubic bone. See Marshall et al., The Correction of Stress Incontinence By Simple Vesicourethral Suspension; Surg. Gynecol. Obstet. Vol. 88, Pps. 509-518 (1949).

With the Burch procedure, sutures are placed at the urethrovesical junction to Cooper's ligament. See Gilja et al., A Modified Raz Bladder Neck Suspension Operation (Transvaginal Burch), J. of Urol. Vol. 153, Pps. 1455-1457 (May 1995). A significant abdominal incision is associated with the Marshall-Marchetti-Krantz procedure. The Burch procedure has been performed abdominally, vaginally and laparoscopically. See Burch, Urelhrovaginal Fixation to Cooper's Ligament for Correction of Stress Incontinence, Cystocele, and Prolapse, Am. J. Obst. & Gynecology, vol. 81 (No. 2), Pps. 281-290 (February 1961); and Das et al., Laparoscopic Colpo-Suspension, J. of Urology, vol. 154, Pp. 1119-1121 (1995).

Needle suspension procedures elevate the urethra retropubically. They include Pereyra, Stamey, Raz, Gittes, Muszani and Vesica procedures. These procedures (except the Vesica procedure) place sutures transvaginally at the urethrovesical junction and are sutured to the abdominal wall through two small abdominal incisions. See Stamey, Endoscopic Suspension of the Vesical Neckfor Urinary Incontinence in Females, Ann. Surgery, pp. 465-471, October 1980; Pereyra, A Simplified Surgical Procedure for the Correction of Stress Incontinence in Women, West. J. Surg., Obstetrics & Gynecology, pp. 243-246, July-August 1959; Holschneider et al., A Modified Pereyra Procedure In Recurrent Stress Urinary Incontinence: A 15-Year Review, Obstetrics & Gynecology, vol. 83, No. 4 Pps. 573-578 (1994). The Vesica procedure includes an abdominal incision where bone anchors are driven into the top of the pubic bone and sutures attached to the bone anchors are placed at the urethrovesical junction. Bone anchors or screws raise the possibility of bone infection, necrosis and other complications, although such complications are rare.

The first sling procedure was the Goebel-Stoeckel-Frannenheim procedure. The sling was autologous fascia that was placed beneath the urethra and suspended by sutures attached to the rectus fascia of the abdominal wall.

There are two general types of sling procedures. The first type of sling procedure utilizes bone screws and associated sutures to anchor a sling (e.g. on a posterior portion of the pubic bone). A commercial example of a bone screw sling procedure is a surgical procedure that utilizes the In-Fast Sling System, available from American Medical Systems of Minnetonka, Minn.

The second type of sling procedure is a minimally invasive surgical method involving the placement (e.g. by the use of a Stamey needle or other ligature carrier) of a sling to stabilize or support the bladder neck or urethra. See Horbach et al., A Suburethral Sling Procedure With Polytetrafluoroethylene For the Treatment of Genuine Stress Incontinence In Patients With Low Urethral Closure Pressure, J. Obstetrics & Gynecology, vol. 71, No. 4, Pps. 648-652 (April 1998); and Morgan et al., The Marlex Sling Operation For the Treatment of Recurrent Stress Urinary Incontinence: A 16 Year Review, Am. J. Obstet. Gynecol., vol. 151, No. 2, Pps. 224-227 (January 1985).

The second type of sling procedure (pubovaginal sling procedures that do not include bone anchors) anchor slings in the abdominal or rectus fascia. These types of procedures involve puncturing the abdominal wall of the patient to pass a needle. Complications associated with sling procedures are rare, but they include urethral obstruction, infection, development of de novo urge incontinence, bladder perforation, hemorrhage, prolonged urinary retention, and damage to surrounding tissue (e.g. caused by sling erosion). The likelihood of complications due to abdominal incisions varies and depends on the particular surgical procedure.

Research is costly as clinical data is expensive to obtain and disseminate. Traditional journal publications (e.g. Tamussino et al., The Austrian Tension Free Vaginal Tape Registry, Int. Urogynecol. J. (2001) (Supp 2):S28-29) continue to be used to disseminate this type of information.

### BRIEF SUMMARY

In one aspect, the present invention is directed to the evaluation and improvement of healthcare by collecting, managing and disseminating information relating to the treatment of incontinence, pelvic floor disorders, and the like.

In a preferred embodiment, the present invention is directed to a sling registry. The registry may be used to evaluate and improve the quality of health care by collecting and disseminating information relating to the treatment of urological disorders such as incontinence.

Preferably, the registry includes an Internet site, accessible from any Internet connection. The Internet site may afford downloading and printing of paper forms for convenience of use. The information obtained and managed according to the present invention may be used for publications, the benefit of patients, for grand rounds/referring physician talks and for managed care. The information may also be used for clinical data for regulatory submissions or other purposes.

The present invention may afford a relatively broad physician base (e.g. a international and/or national and/or large group of participants) at potentially reduced resource allocations. Optionally, there can be a broad patient base with few, if any, inclusion or exclusion criteria.

The present invention also affords the ability to review and analyze particular subsets of data. For example a physician may rapidly review and analyze data from patients with and without ISD, with and without concomitant repairs, with and without urge incontinence. Additionally, physicians may rapidly compare results from patients who have had previous pelvic surgeries with those who have had no previous pelvic procedure.

The present invention may be utilized to collect and manage publishable information. Optionally, the present invention may include a feature wherein standards of what data will be included in the publication are set before the data is collected.

The publication may be used for single or multi-site data. The present invention may be used to manage grants (e.g. those available for specific protocols).

The present invention may optionally include features that prevent the manager of the registry from auditing physician records, from dictating inclusion and exclusion criteria to physicians, from publishing individual physician or patient results, or from comparing individual physician performance. Also optionally, the registry may include a feature for obtaining individual patient informed consent.

An advantage of the present invention is that is may be readily used to track patient data for an extended period of time (e.g. years). It can be used to provide reminders to surgeons concerning the need for follow-up visits and data collection, and other information such as whether a surgeon is following a protocol (e.g. created by a third party such as a medical device manufacturer or customized by a particular surgeon).

The present invention may also be used by a manufacturer of a surgical product to improve the product, add or remove accessories to a surgical kit, and to modify existing products. For example, the present invention may help conclude that a particular procedure (e.g. a sling procedure) results in an unacceptably high incidence of a particular complication (e.g. bladder perforation). The information gathered and managed according to the present invention may then be used to modify the particular surgical product to reduce the chances of the complication. For example, the needle used in the procedure may be improved, modified or changed in some manner. Alternatively, the instructions for use of the surgical product may be altered by the method of managing urological data according to the present invention.

In one aspect, the present invention comprises a method of managing information useful in pelvic floor repair comprising the steps of a) providing a computer system capable of receiving information via a network, the computer system having processing means for managing the information; b) receiving information related to a patient's pelvic floor disorder via the network and recording the information in the computer system, c) sorting the information with the processing means, and d) outputting results of the sorting. Preferably, the step of sorting the information includes the step of sorting the information into at least one group selected from the groups consisting of patients with a predetermined preexisting condition such as intrinsic sphincter deficiency, patients without a predetermined preexisting condition, patients undergoing concomitant repairs, patients who did not undergo concomitant repairs, patients with urge incontinence, patients without urge incontinence, patients with previous pelvic surgery, and patients without previous pelvic surgeries.

The method may optionally include the step of using the information: a) to improve a product (e.g. a sling), or b) to alter components of a surgical kit, or c) for a publication for the medical community, or d) to alter instructions for use, or e) to generally improve the quality of healthcare.

In a preferred embodiment, the computer system has a first database that includes a plurality of different treatment regimens, a second database with criteria for evaluating and selecting a therapeutic treatment regimen from the first database, and a processing means for comparing information from a patient to be treated with the first database and the second database.

A variety of different embodiments are contemplated for the step of outputting results of the sorting. For example the outputting step can include the step of displaying data on a screen (e.g. a proposed treatment regimen generated by the processing means) or providing data to a printer for purposes of a hard copy document. In the sling registry embodiment of the present invention, the step of displaying a proposed treatment regimen may include displaying post operation instruction (e.g. displaying instructions for loosening or tightening the sling).

The present invention is flexible concerning the amount, type or value of information received, and the subsequent treatment thereof. For example, generating urodynamic and cystometry data requires capital equipment that is generally expensive. Thus, this type of data is generally more valuable than quality of life (QOL) data which is generally less expensive to obtain.

In another aspect, the present invention comprises a method of managing information useful in treating incontinence comprising the steps of: a) providing a computer system capable of receiving information via a network, b) receiving information related to implantation of a sling on a patient via the network and recording the information in the computer system, and c) making a payment in exchange for receiving the information related to the implantation of the sling. Preferably, the step of receiving information includes the steps of receiving initial patient information and then subsequently receiving follow up patient information collected at a predetermined time following the implantation of the sling. The step of making a payment in exchange for receiving the information includes the step of making an additional payment after receipt of the initial patient information and making a second payment after receipt of follow up patient information.

In another aspect, the present invention comprises media, having recorded thereon, software which upon installation in a computer and execution of the software will afford use of the computer to carry out the method comprising: a) receiving information related to a sling procedure via a network, b) recording the information in the computer, c) sorting the information, and d) outputting results of the sorting. In this embodiment, the step of sorting the information preferably includes the step of sorting the information into at least one group selected from the groups consisting of patients with a predetermined preexisting condition such as intrinsic sphincter deficiency, patients without a predetermined preexisting condition, patients undergoing concomitant repairs, patients who did not undergo concomitant repairs, patients with urge incontinence, patients without urge incontinence, patients with previous pelvic surgery and patients without previous pelvic surgeries.

In another aspect, the present invention comprises a computer system for managing information useful in pelvic floor repair. The computer system includes means for receiving information related to pelvic floor repair via a network, processing means for managing the information including recording means for recording the information and sorting means for sorting the information with the processing means, and means for outputting results of the sorting means. The output means may comprise means for outputting to a personal computer, via a network connection or to a printer. In a preferred embodiment, the processing means includes means for triggering a payment in exchange for receiving the information related to the implantation of the sling.

These and other advantages of the invention are more fully shown and described in the drawings and detailed description of this invention, where like reference numerals are used to represent similar structures. It is to be understood, however, that the drawings and description are for the purposes of illustration only and should not be read in a manner that would unduly limit the scope of this invention.

### BRIEF DESCRIPTION OF THE DRAWING

Other features and advantages of the present invention will be seen as the following description of particular embodiments progresses in conjunction with the drawings, in which:

FIG. 1 is a depiction of a user interface that affords password protected access to a patient registry according to one aspect of the present invention;

FIG. 2 is a depiction of a computer screen of a preferred embodiment of patient registry according to the present invention;

FIG. 3a is a depiction of a user interface for receiving patient information according to a preferred embodiment of the present invention;

FIG. 3b is a continuation of the user interface of FIG. 3a;

FIG. 3c is a continuation of the user interface of FIG. 3b;

FIG. 3d is a continuation of the user interface of FIG. 3c;

FIG. 4 is a depiction of a user interface for receiving complication information for a preferred embodiment of patient registry according to the present invention;

FIG. 5 is another computer screen for receiving complication information concerning a sling operation;

FIG. 6 is another user interface for use in a preferred embodiment of the present invention to obtain information concerning the type of sling operation performed;

FIG. 7 is a computer screen useable to order summary information according to an aspect of a preferred embodiment of the present invention;

FIG. 8 is a screen useable to modify or supplement patient data to, for example, add data obtained during a follow up visit;

FIG. 9A is a depiction of a user interface according to an aspect of a preferred embodiment of the present invention showing a sample procedure report;

FIG. 9B is a depiction of a user interface according to an aspect of a preferred embodiment of the present invention showing a history report;

FIG. 9C is a depiction of a user interface according to an aspect of a preferred embodiment of the present invention showing an efficacy report;

FIG. 9D is a depiction of a user interface according to an aspect of a preferred embodiment of the present invention showing a complication report;

FIG. 9E is a depiction of a user interface according to an aspect of a preferred embodiment of the present invention showing a history report;

FIG. 9F is a depiction of a user interface according to an aspect of a preferred embodiment of the present invention showing a sample procedure report;

FIG. 9G is a depiction of a user interface according to an aspect of a preferred embodiment of the present invention showing a sample follow-up report;

FIG. 9H is a depiction of a user interface according to an aspect of a preferred embodiment of the present invention showing a sample procedure report;

FIG. 10 is a schematic illustration of a generic network that can involve interaction of individuals using different computers;

FIG. 11 is a schematic description of a computer system for use in the patient registry of the present invention;

FIG. 12 is a flowchart of a preferred use of a patient registry according to one aspect of the present invention;

FIG. 13 is a flowchart of another preferred use of a patient registry according to another aspect of the present invention;

FIG. 14 is a flowchart of another preferred use of a patient registry according to another aspect of the present invention;

FIG. 15 is a flowchart of another preferred use of a patient registry according to another aspect of the present invention; and

FIG. 16 is a flowchart of another preferred use of a patient registry according to another aspect of the present invention.

### DETAILED DESCRIPTION

The following description is meant to be illustrative only and not limiting. Other embodiments of this invention will be apparent to those of ordinary skill in the art in view of this description.

The present invention is directed to systems, apparatus, and methods useful for pelvic floor repair or reconstruction technologies, such as soft tissue repair and implantation procedures such as sling procedures for treating incontinence. Male and female health technologies are within the scope of the present invention. Examples of pelvic floor repairs and reconstruction include, but are not limited to uterosacral ligament fixation, vault prolapse repair, sacrospinous ligament fixation, paravaginal defect repairs, repairs of cystoceles, rectoceles, and enteroceles, and other prolapse repair or combinations of concomitant repairs. In a preferred embodiment, the present invention relates to a sling registry associated with the treatment of urinary incontinence.

In one aspect, the present invention comprises a method of managing information useful in pelvic floor repair including the steps of: i) providing a computer system capable of receiving information via a network, the computer system having processing means for managing the information; ii) receiving information related to a patient's pelvic floor disorder via the network and recording the information in the computer system, iii) sorting the information with the processing means, and iv) outputting results of the sorting. The information may be used or managed by an individual surgeon, a group of healthcare providers, a medical product designer or team, a medical product marketer or other user at a medical product provider. Information provided by one user of the system may be readily shared and communicated with other users. This feature of the system affords the opportunity to align otherwise disconnected surgical practices (e.g., surgical techniques, preferences and experiences). In the past, such surgical practices in the urological field could be quite subtle and may have escaped quantification or communication in the past.

In another aspect, the present invention comprises a sling registry comprising a nation wide database (optionally worldwide). A network (e.g. the Internet) may be used to collect and record the data. Tracking features may be provided. Data management features (e.g. tabulation features) may also be provided.

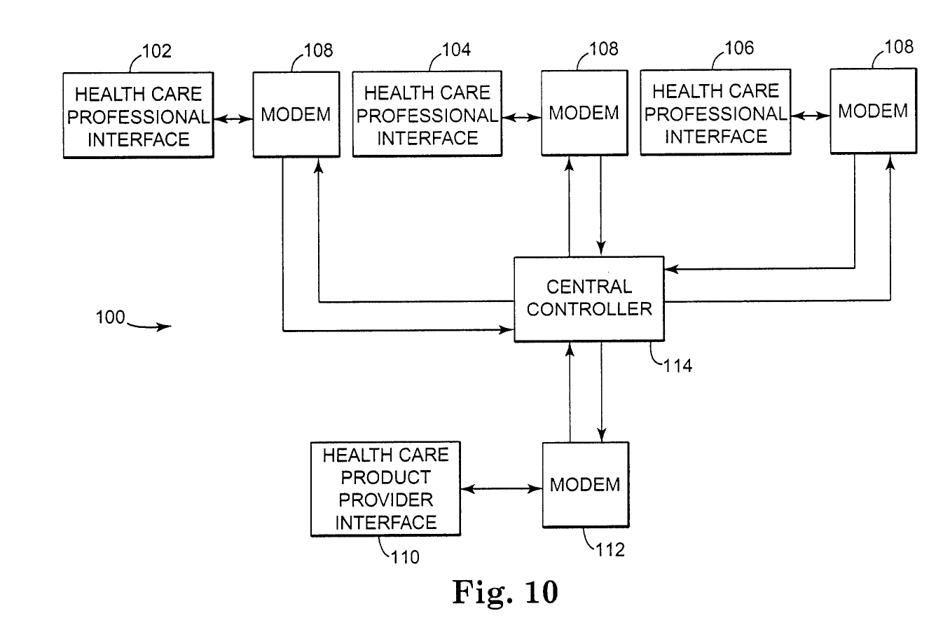

Referring to FIG. 10, a network 100 for use in the present invention may comprise a plurality of user systems 102, 104, 106 and 110, connected via the network to a central controller or system 114. User systems 102, 104 and 106 may comprise, for example, systems, personal computers or workstations under the direction, control, or guidance of doctors, surgeons or other healthcare entities in substantially direct contact with patients. User system 110 may comprise, for example, a mainframe, local area network (LAN), personal computer or like system under the control of a healthcare device or implant supplier, such as the supplier of a surgical kit for a sling procedure for treating incontinence.

The central controller or processor 114 may be provided by a LAN, mainframe computer, Internet website supporting system or the like.

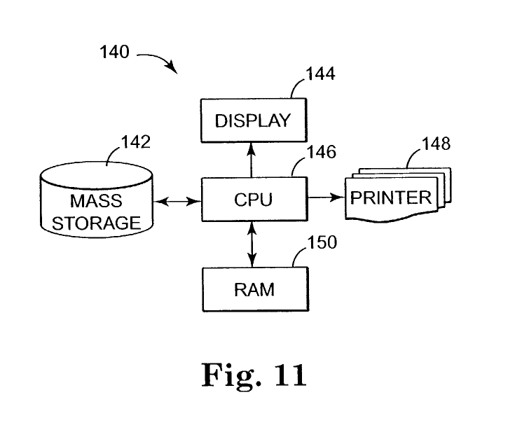

The system 110 and each user system 102, 104, 106 may be generally of the type described as a computer system 140 (described below in conjunction with FIG. 11). The number of users connecting to the network may be fixed or may vary from time to time. The method of connection may be through direct or indirect connections, e.g., by modems 108 and 112, over a dedicated cable or line, over an intervening system (such as the Internet), through an intranet system (e.g. within an entity dedicated to healthcare such as a surgical center, university, teaching hospital or the like), through a wireless connection or by any other appropriate system.

Referring to FIG. 11, computer system 140 includes a central processing unit (CPU) 146, random access memory (RAM) 150, mass storage device 142 (such as a hard drive, CD-ROM drive, diskette drive or the like), a display 144 (such as a cathode ray tube, LED, LCD or plasma display) and a printer 148 (such as a dot matrix printer, a laser printer, or an ink jet printer), associated such that the CPU can read and write to the RAM 150 and the mass storage device 142 can control the images on the display 144 and the output of the printer 148.

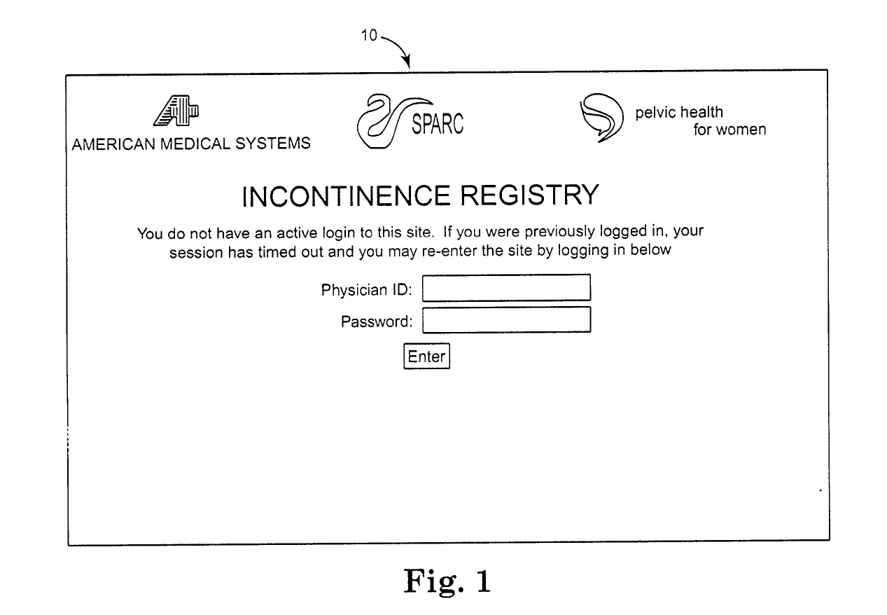

Referring now to FIGS. 1 through 8, there are shown computer screens useable in a sling registry in accordance with one aspect of the present invention. FIG. 1 shows a home page 10 that is optionally password protected. The depicted home page may be customized for a particular product, (e.g. the SPARC sling product) or it may be generalized for a plurality of different types of sling products, components or systems. Examples of sling products, systems and components are described in Published U.S. Pat. Application Nos. 2002/0099258A1 (published Jul. 25, 2002) and 2002/009925A1 (published Jul. 25, 2002).

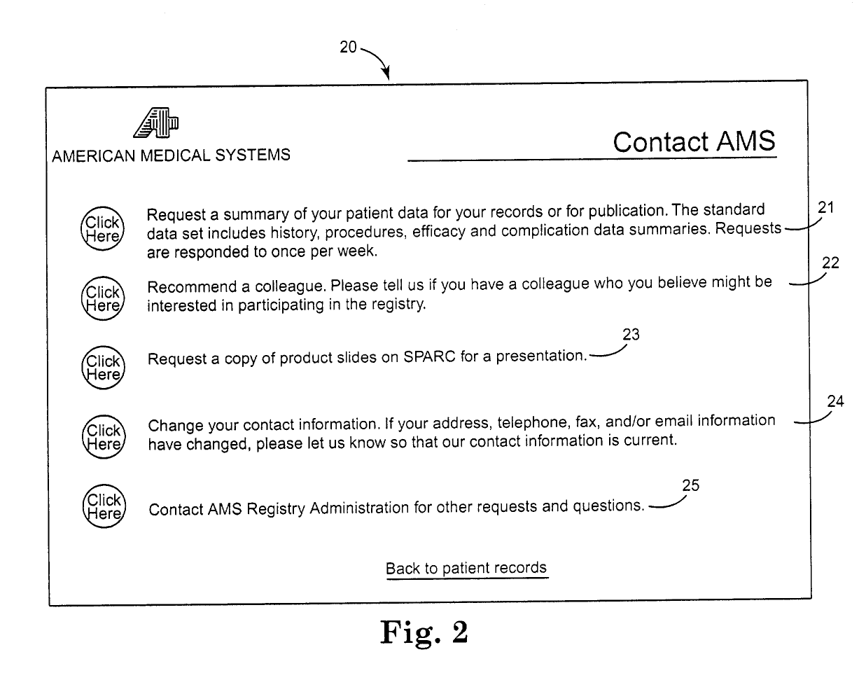

The registry may optionally have a communications page 20 (FIG. 2) for direct communication between a doctor and a healthcare product provider. For example, the doctor may be able to access patient data for his or her records or publication 21. The doctor may be given the opportunity to recommend a colleague 22 (e.g. who has achieved the required experience, education or skill level required of a particular product). Product literature may be provided 23. Contact information may be changed 24, and a miscellaneous communications link (e.g. an e-mail) 25 may be provided.

Optionally, the communication page can afford communication between users. This communication may be between two otherwise disconnected surgeons utilizing otherwise disconnected surgical practices. The system can afford monitoring of such communications or optionally, a feature may be provided to prevent monitoring of such communications.

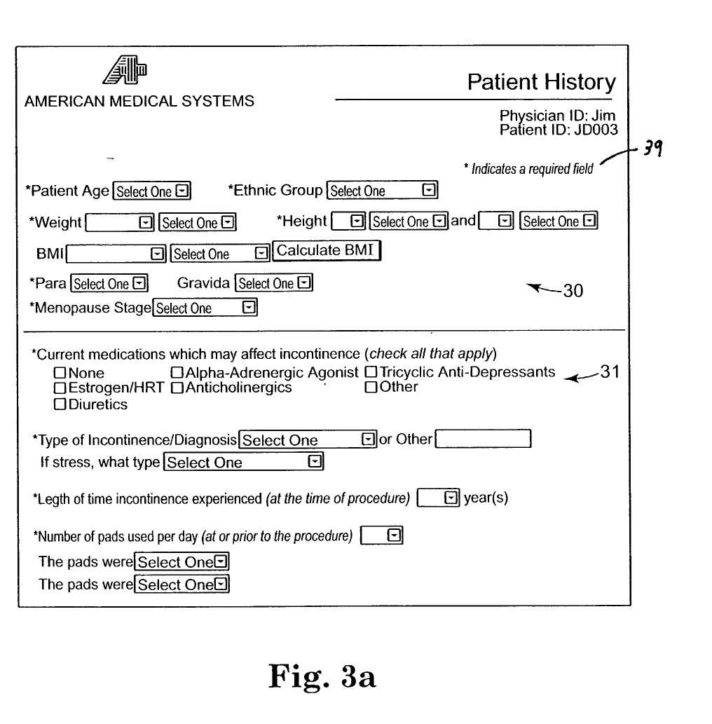

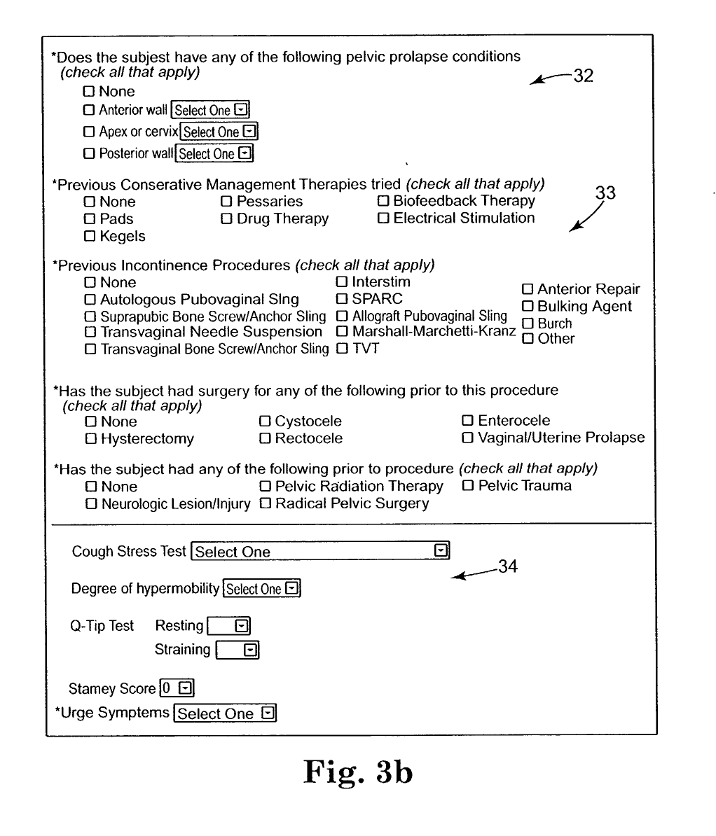

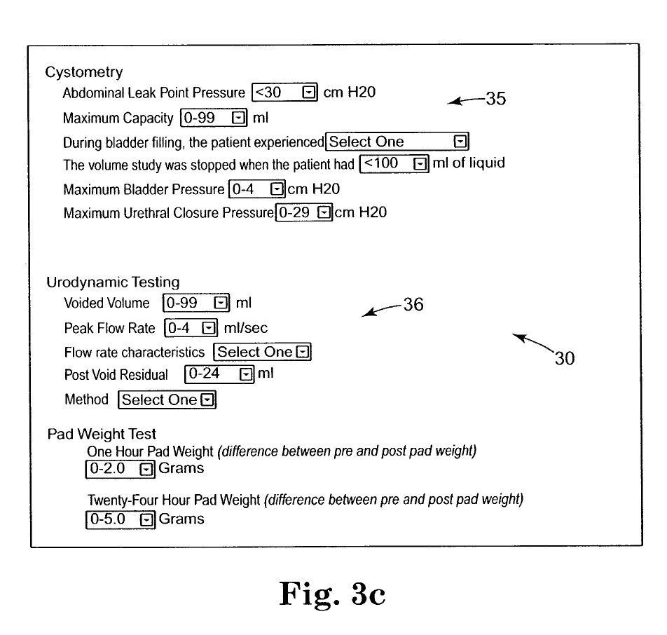

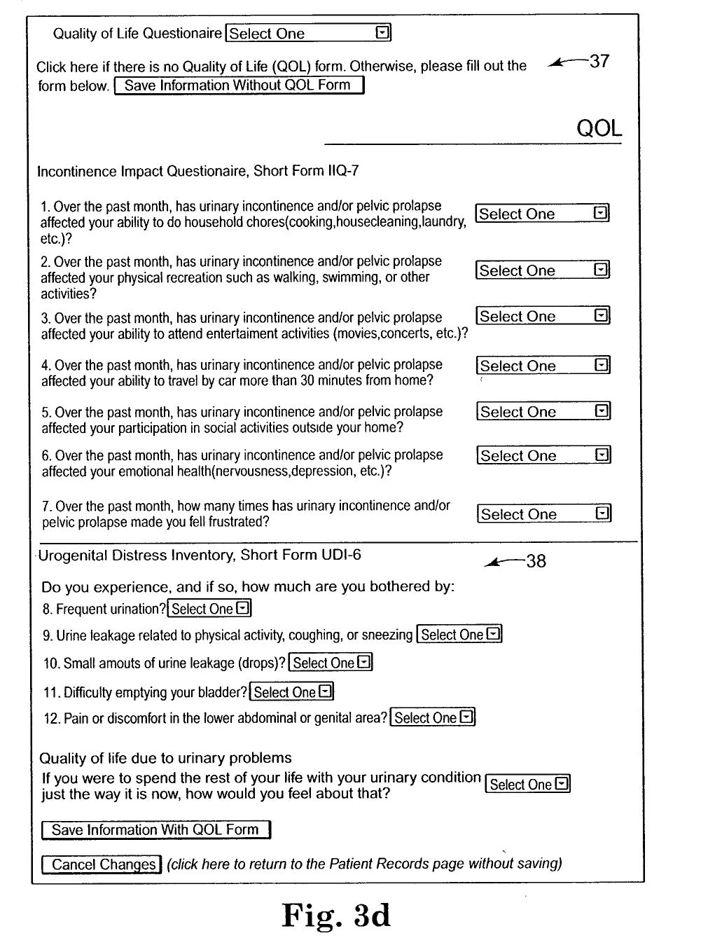

Referring to FIGS. 3a through 3d, the registry preferably affords entry of patient history information 30. Of particular interest may be other medications 31, pre-existing conditions 32, previous therapies or procedures 33, objective test performance data 34 such as the Q-Tip test, cystometry data 35, urodynamic test data 36 and quality of life (QOL) data 37. Required fields 39 may optionally be identified.

Quality of life data may be any suitable standardized data relied upon in the local medical community. It may also include data customized or tailored for a particular user of the system (e.g. a surgeon or medical product provider). Examples include data from Health Status Questionnaire 2.0 of the Microtest Q™ Assessment System, generally available from NCS Assessments of Minneapolis, Minn.; data from SF-36v2™ Acute Version (2001), generally available from QualityMetric, Inc. of Lincoln RI, data 37 from the Incontinence Impact Questionnaire (Short Form II Q-7), Incontinence Impact Questionnaire (Long Form), and data 38 taken from Urogenital Distress Inventory, Short form UDI-6. Notably, other standardized quality of life data and the like may be incorporated into the registry of the present invention. Examples are disclosed in Groutz, A., Blaivas, J. G. and Rosenthal, J. E.: A simplified urinary incontinence score for the evaluation of treatment outcomes, Neurourol. Urodyn. 19:L 127 (2000); and Blaivas, J. G., Appell, R. A. Fantl, J. A. et al. Standards of efficacy for evaluation of treatment outcomes in urinary incontinence: recommendations of the Urodynamic Society, Neurourol. Urodyn., 16: 145 (1997); and Shumaker et al, Health-Related Quality of Life Measure for Women with Urinary Incontinence: the Incontinence Impact Questionnaire and the Urogenital Distress Inventory, Continence Program in Women (CPW) Research Group. Qual. Life Res. 1994, 3:291-306; and Shortliffe and Stamey, Urinary Incontinence in the Female, Ch. 73 of Campbell's Urology (5^{th} edition), pp's. 2680-2711, W. B. Saunders Co. (1986). Other quality of life questionaire samples may be obtained from the Incontinence Research Foundation, of Encinitas, Ca.

The registry may optionally be tailored by an individual user (e.g. a surgeon) to only include predetermined information preferred by him or her, and to exclude other information. This simplifies and streamlines the process. It can also take into account the vagaries associated with local practice. For example, when urodynamic data is taken in the United States, a leak point pressure test is commonly conducted, but such a test is rare in Europe. In Europe, a urethral pressure profile (UPP) is more commonly used. A surgeon who uses the registry to enter information concerning patients treated in the U.S. would likely choose to exclude data related to urethra pressure profiles. Allowing a surgeon to exclude this type of information affords convenient and efficient management of the information.

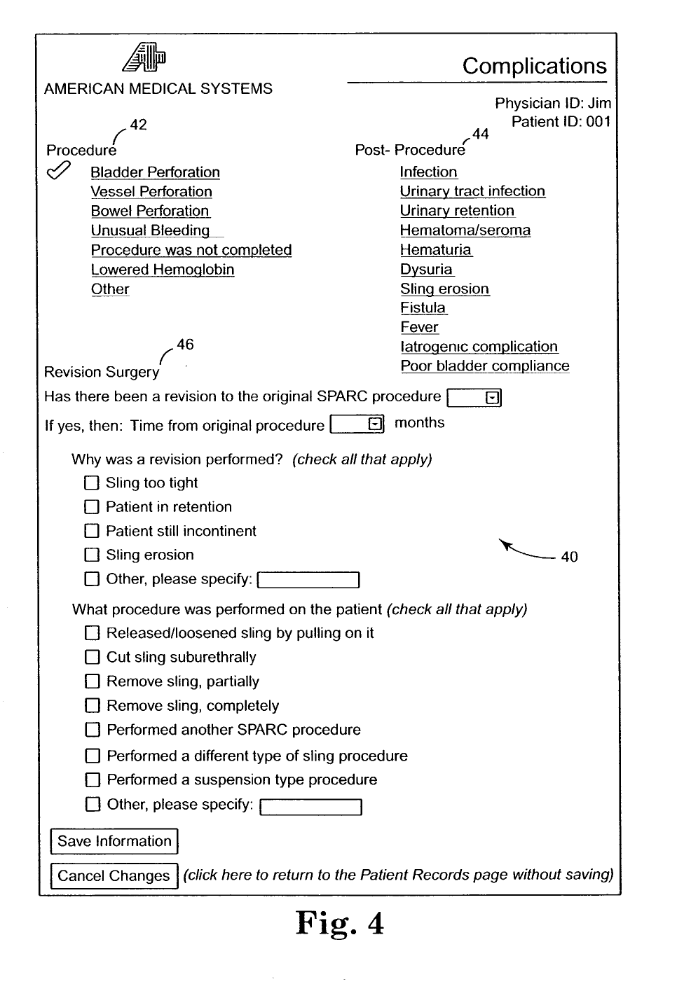

The registry 10 is also capable of receiving, recording and processing complication data 40, as shown in FIG. 4. The complications data can include data associated with complications encountered during the procedure 42 and post-procedure complications 44. It can also include historic data.

The registry may also be designed to record, track and manage revision information 46. For example, if the sling is placed too loosely, the patient may remain incontinent. If the sling is placed too tight, the patient may be placed in retention or the sling may erode into surrounding tissue (e.g. the urethra or vagina). A revision may be required to remove the sling or change its tension.

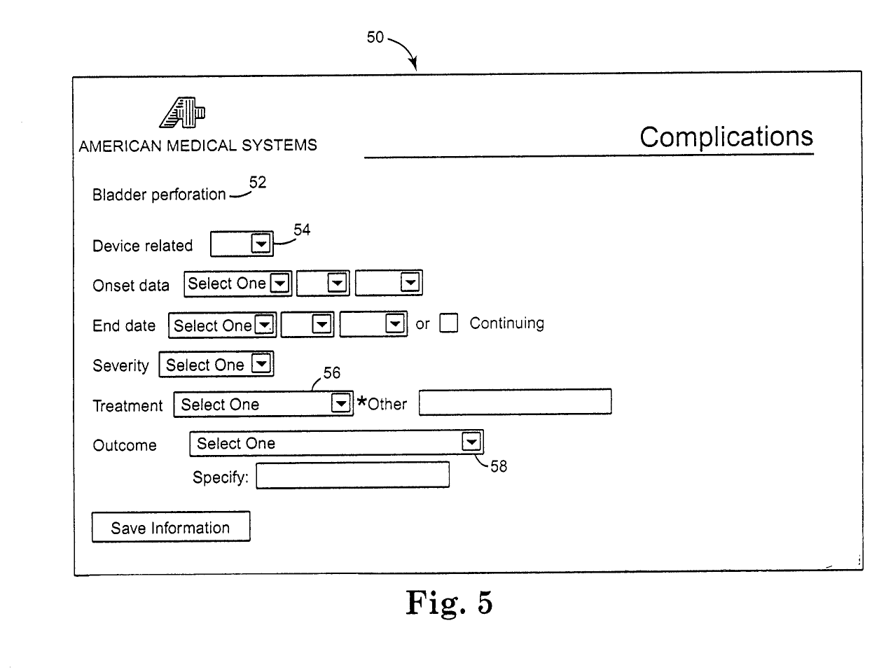

FIG. 5 illustrates a preferred computer screen for the registry used to receive complication information such as bladder perforations 52, other device or implant related complications 54, treatments 56 for the complications and outcomes 58.

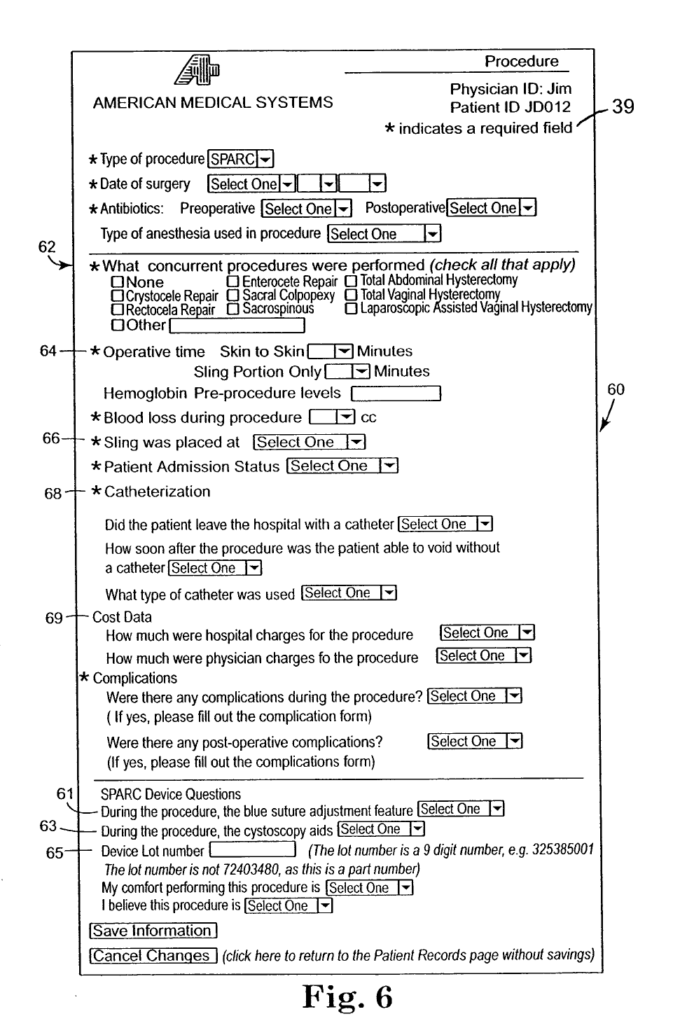

FIG. 6 illustrates a computer screen 60 suitable for gathering information concerning a particular procedure on a patient. While the depicted procedure is a SPARC sling procedure, other suitable sling procedures are also within the scope of the present invention including TVT procedures, generally available from Ethicon, a division of Johnson and Johnson, and the Uretex sling procedure, available from Sofradim of Trevoux France or Bard, U.S.A.

The information 60 preferably includes the date of the surgery, the antibiotics and anesthesia used (e.g. local or otherwise), concomitant procedures 62, operative times 64 and components thereof, the location of the placement of the sling (e.g. mid-urethra or at the bladder neck), the catheterization status 68 of the patient (e.g. the number of days catheterization is required), and cost data 69. Required fields 39 may optionally be identified. The system may optionally include a feature encouraging a surgeon to follow a particular protocol. For example, the system can prevent a user from proceeding or may change color if a particular protocol is not being followed.

Surgical device or implant information may be gathered. For example, with the SPARC system, information concerning the tensioning suture 61, cystoscopic aids 63 and device lot number 65 may be recorded and managed.

While the information shown in FIG. 6 relates to commercially available products, it is noted that the information need not be identified by a commercial trade name or trademark. Other information and methods for identifying information may be utilized. For example, data concerning only a portion of a sling kit or procedure may be tracked, recorded and managed. For example, information concerning non-synthetic sling materials including allografts, homografts, heterografts, autologous tissues, cadaveric fascia and fascia lata may be recorded, processed, tracked and managed. As another example, information concerning synthetic materials for slings including polypropylenes, polyesters, polytetrafluoroethylenes, polyethylene terepthalates, and particular grades, weaves or other characteristics thereof may be tracked for comparison or performance evaluation purposes. Sling size, length or bias of the weave of a sling are also believed to be data targeted for tracking, managing and monitoring in accordance with the present invention.

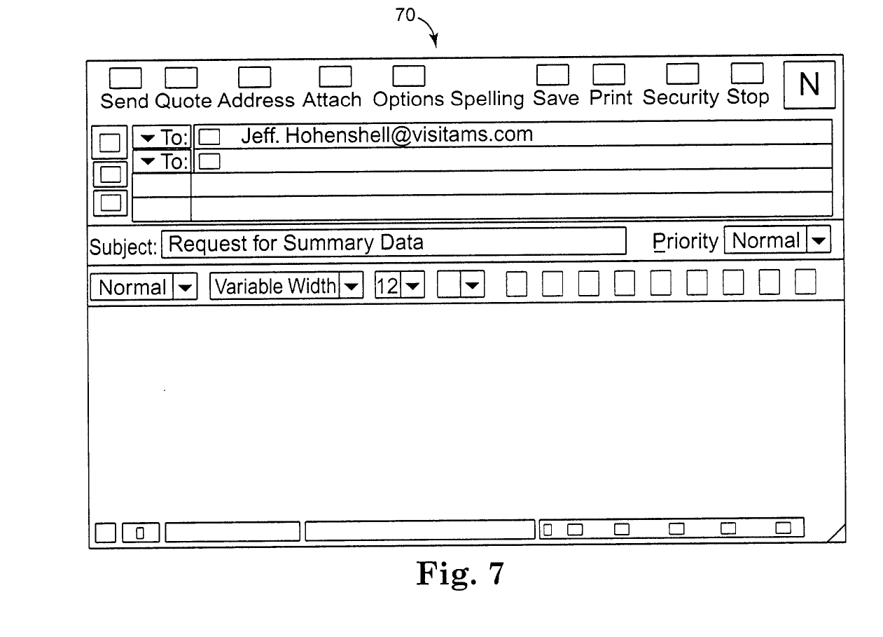

FIG. 7 illustrates a request for summary data 70 that a doctor (e.g. user 102 in FIG. 10) may make to a healthcare product provider 110 (e.g. the provider of the SPARC Sling System) through the use of the sling registry according to the present invention.

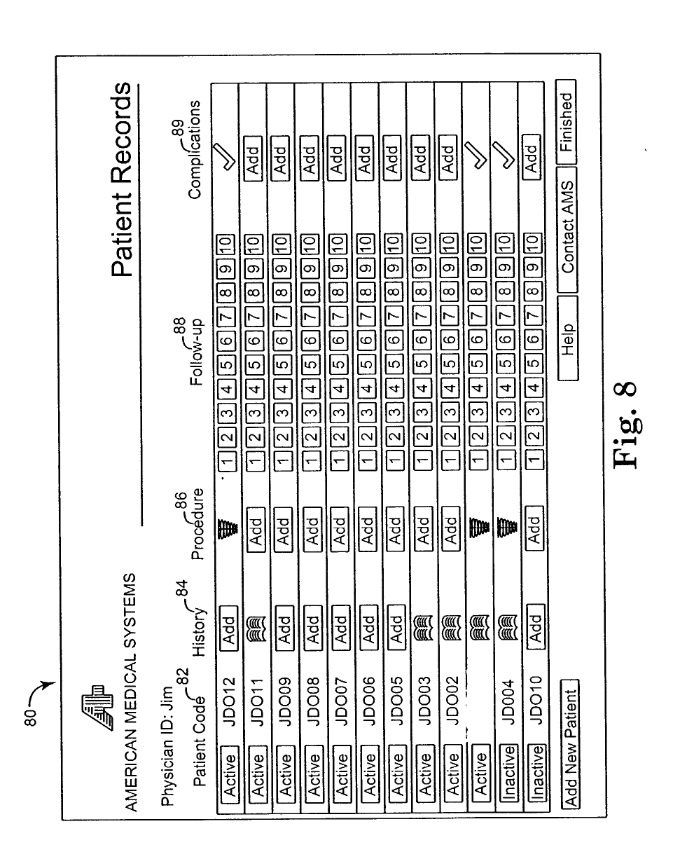

FIG. 8 is a user interface 80 that allows a doctor to create and modify patient record information. The interface 80 preferably includes a patient code 82 for a particular patient, the patient history 84, the specific procedure 86 performed on the patient, follow patient visit information 88 and complications information 89. Suitable icons may be used for convenience of creating and editing the patient information.

Referring to FIG. 10, the central controller 114 is preferably capable of separating the information from the registry into groups such as patients with a predetermined preexisting condition such as intrinsic sphincter deficiency, patients without a predetermined preexisting condition, patients undergoing concomitant repairs, patients who did not undergo concomitant repairs, patients with urge incontinence, patients without urge incontinence, patients with previous pelvic surgery, and patients without previous pelvic surgeries. Other sorting and management of information is within the scope of the present invention. For example, a surgeon may wish to compare complications associated with slings placed at the bladder neck with slings placed at the mid-urethra. Particular complication data (e.g. infections or erosions) may be compared for the slings placed at these particular locations.

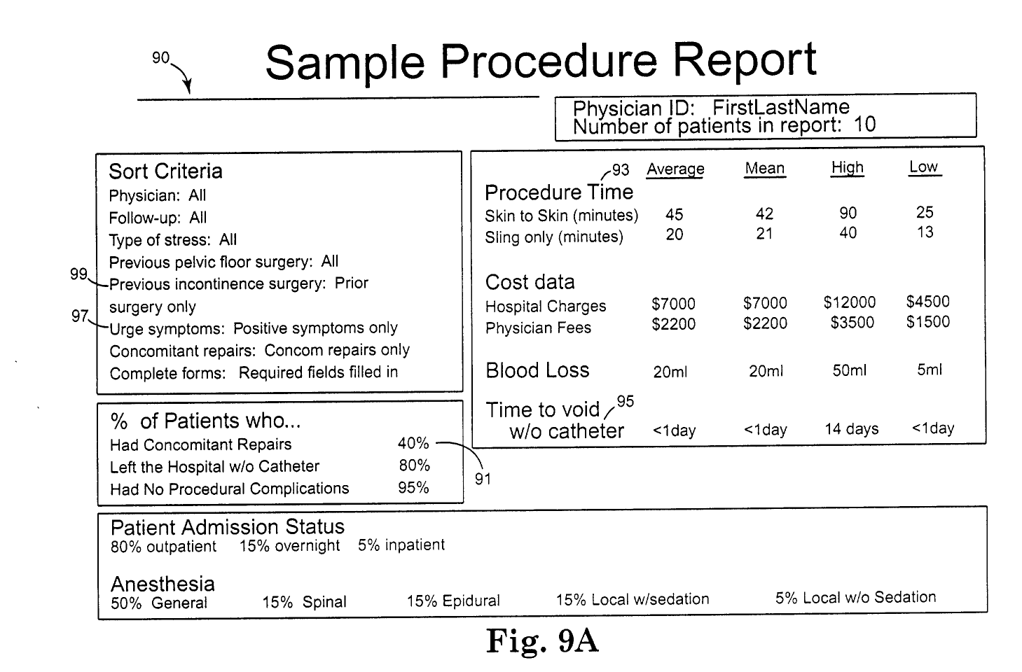

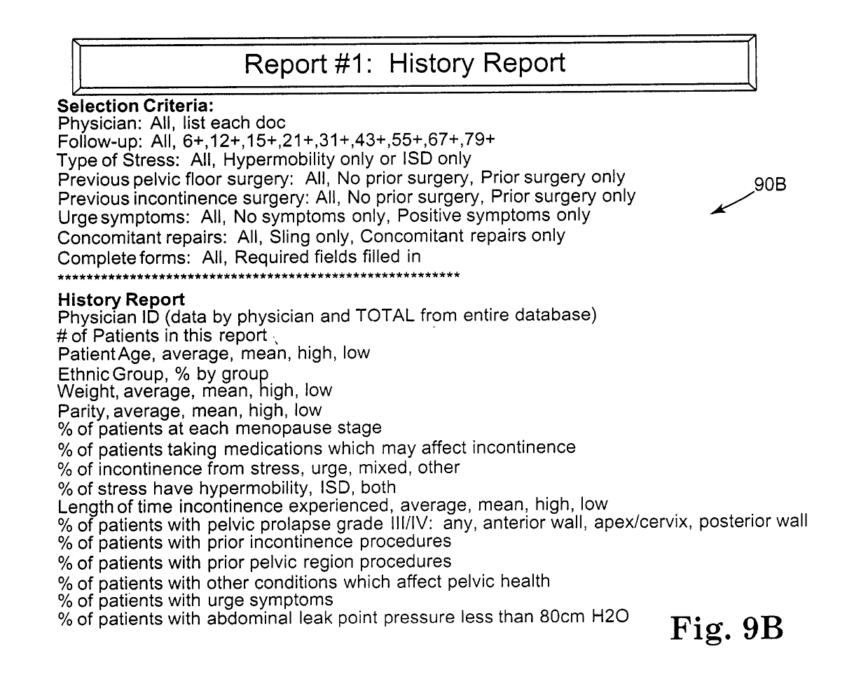

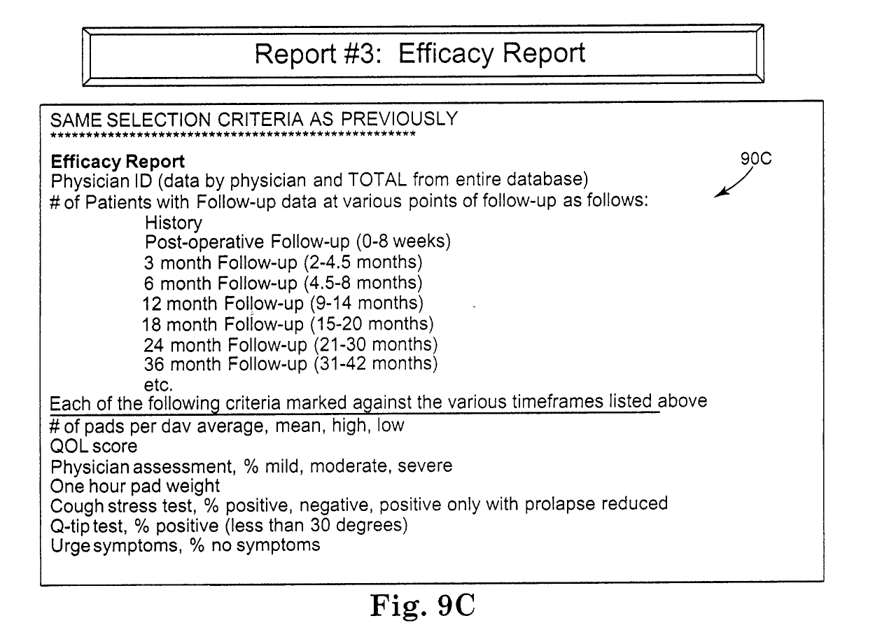

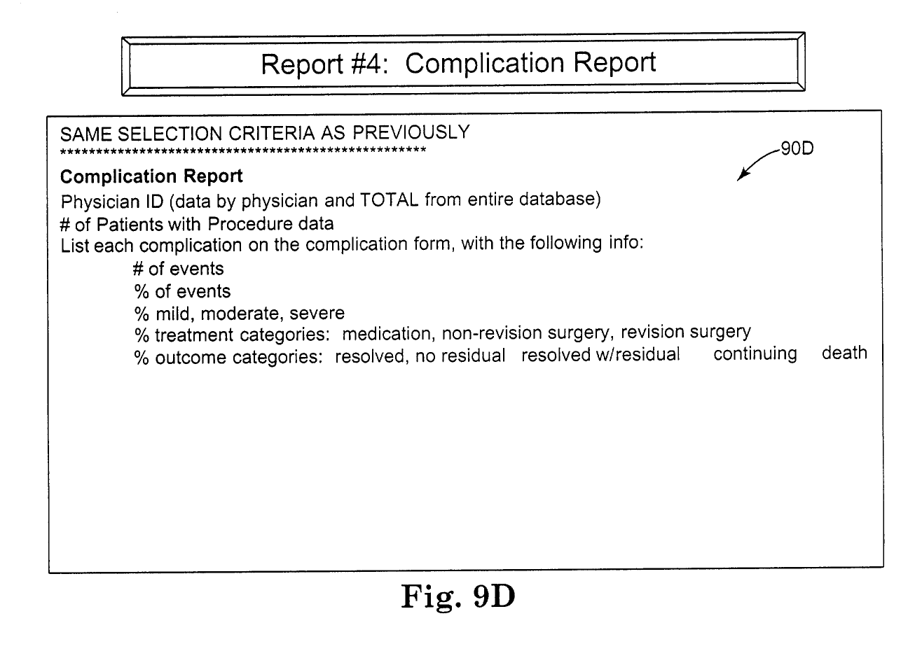

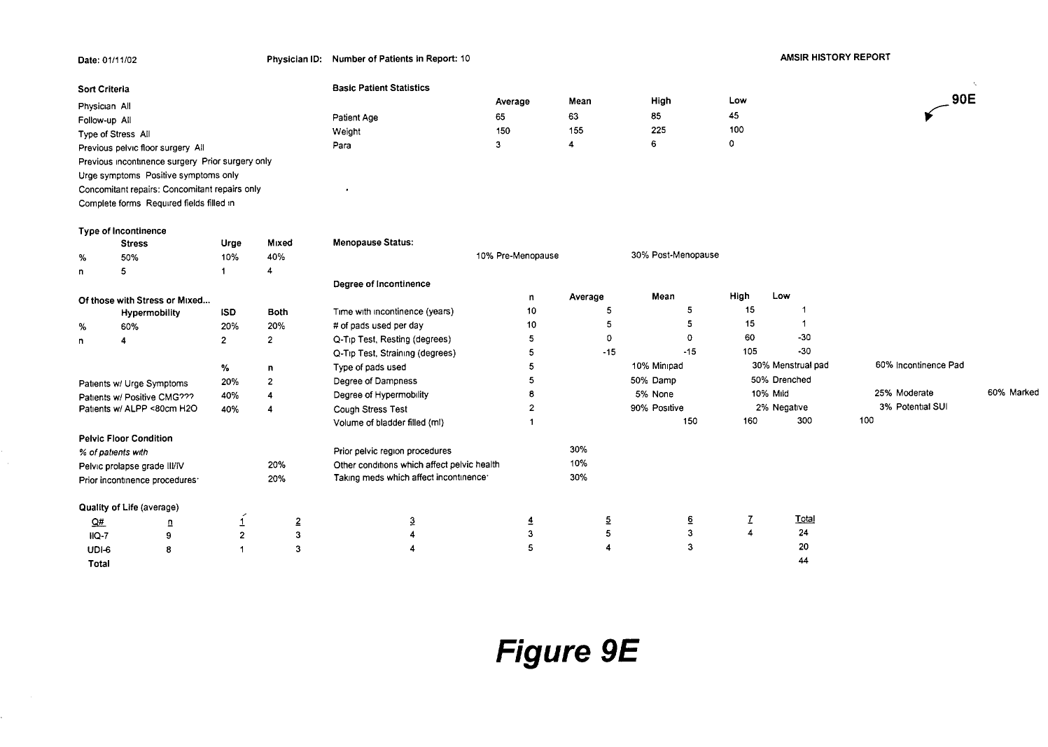

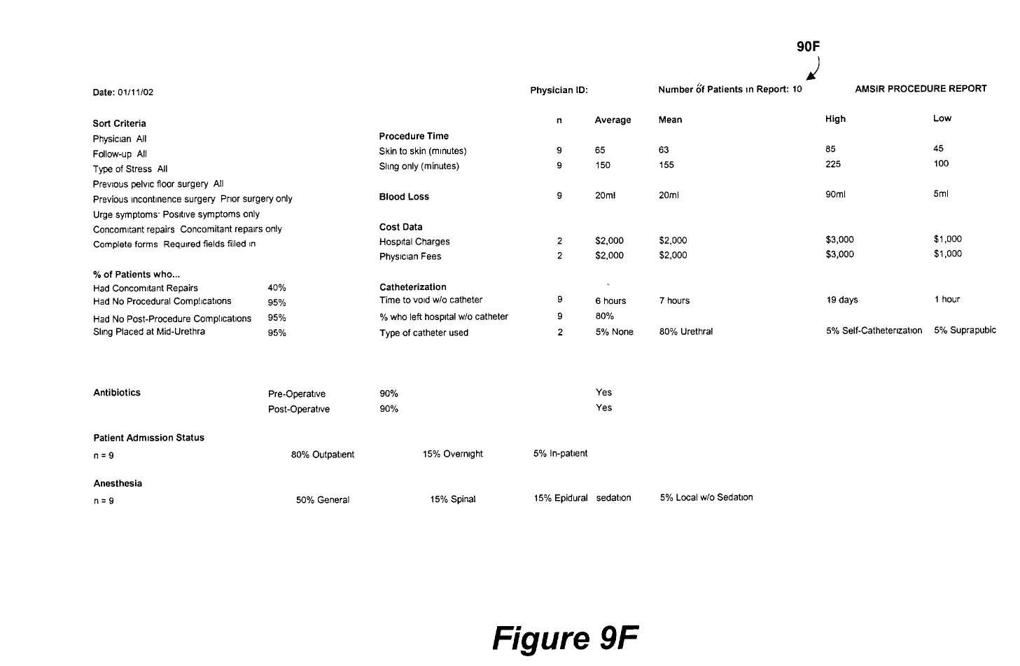

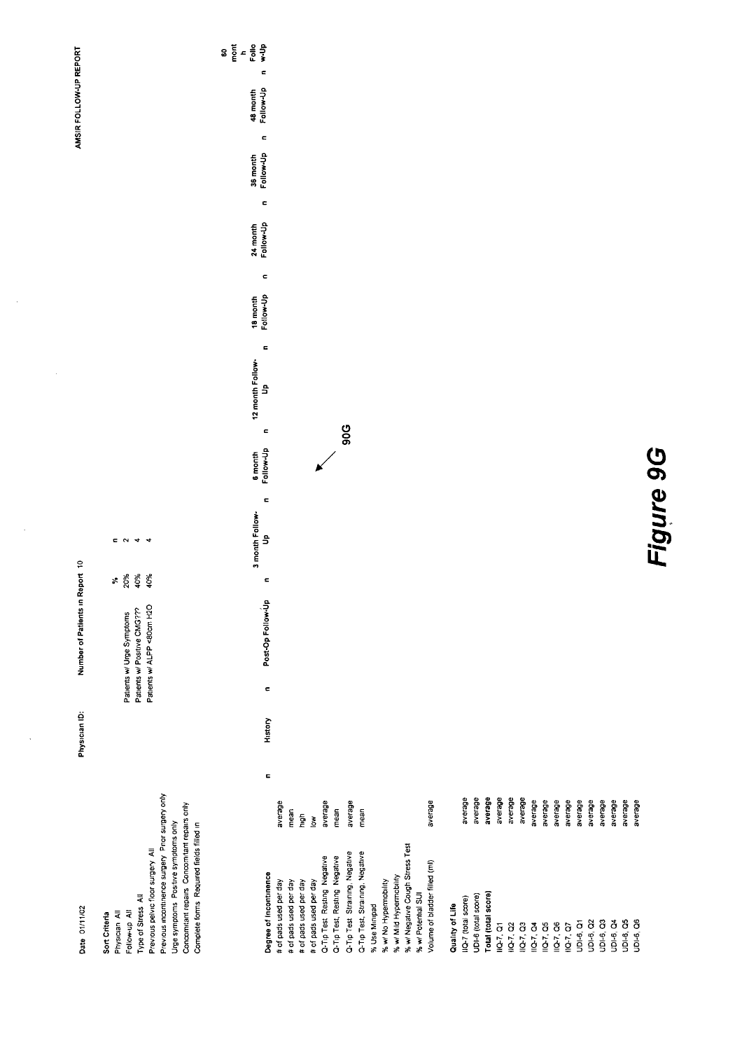

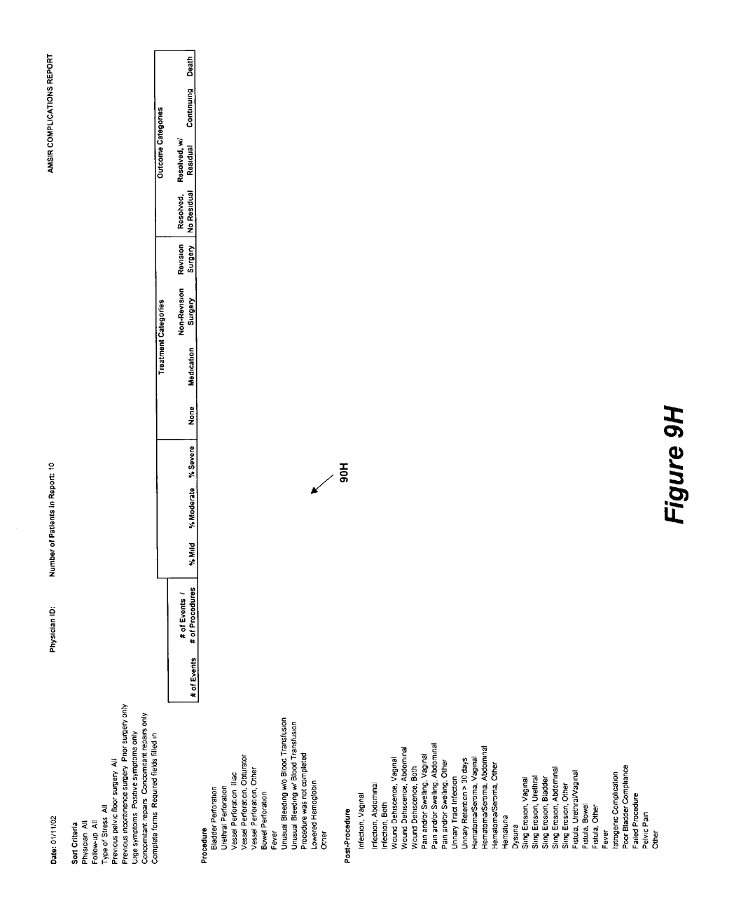

FIG. 9A is a sample procedure report generated by sorting patient data with a processing means in the central controller 114. This report displays, among other information, the procedure time 93, and catheter information 95. The report includes, among other sort criteria, patients with previous incontinence surgery 99 and urge systems 97. FIG. 9B is another report with selection criteria 90B and history report output. FIG. 9C is an efficacy report with follow-up data 90C reported.

FIG. 9D is a complications report 90D for patients with a particular “Procedure”. Optionally, the registry may include a feature that allows an individual to compare his or her own complications data with the pool of data in the registry, but can prevent other surgeons from viewing his or her performance data.

FIG. 9E is another, more detailed history report 90E. This history report 90E includes, among other data, types of incontinence, pelvic floor condition, quality of life data and other basic patient statistics.

FIG. 9F is another procedure report 90F. This report includes procedure time and the amount of catheterization associated with the surgery.

FIG. 9G is a depiction of a user interface showing a sample follow-up report 90G. The follow up report can be utilized to track patient data over time.

FIG. 9H is another complications report 90H. This report separates complications into post surgical complications and those encountered during the procedure.

The system according to the present invention is believed to be particularly suitable for identifying measurable sources of complication. By “measurable sources of complications”, it is meant that those complications that are statistically significant and about which information is capable of being gathered.

In one embodiment, the present invention may be used to identify a surgical sling procedure including the implantable sling material, the surgical articles used during procedure and the instructions for use, and record the information relating to the surgical sling procedure in a database. The system can record complications exhibited by a patient after a surgical sling procedure via the Internet. The information can be information only associated with a particular procedure or it can include similar types of procedures. The system can then be used to identify measurable sources of complications associated with a surgical sling procedure, the implants or the instructions for use.

For example, for a particular SPARC Sling product, the database may record that the implantable material is a polypropylene weave with certain characteristics, that the surgical articles include a small (e.g. 3 mm diameter needle), and that the instructions for use call for passing the needles initially through an abdominal incision and causing the needle to emerge through a vaginal incision. Next, information concerning SPARC procedures and TVT procedures can be collected via the Internet and compared. This information can be used to identify measurable sources of complications associated with either the SPARC procedure or the TVT procedure or both procedures. The system can help identify measurable sources of a complication associated with a particular implantable sling material and output the results to users of the system. For example, the system can be used to identify that a bladder perforation is more likely to occur with a larger insertion needle or with a transvaginal (TVT) needle approach than with a smaller needle or a transabdominal (SPARC) approach.

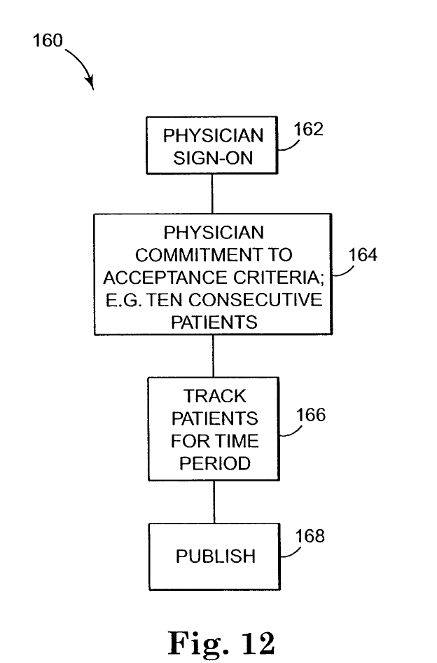

The patient registry may be particularly suitable for managing, organizing and presenting information for publication. FIG. 12 illustrates a flowchart 160 for using the patient registry. Once the physician signs on 162, the physician may commit to criteria acceptable to the publishing entity (e.g. a journal) or inclusion criteria of a study. For example, the journal may require ten consecutive patients be reported 164. The system may be readily tailored for other publication acceptance requirements or inclusion criteria. The patients are typically tracked for a period of time (e.g. over 1 year) with one or more follow-up visits. Once the information has been gathered and the time has elapsed, the registry may be used to publish 168 the information. For some acceptance criteria or inclusion criteria, the publication may be automatic (e.g. through non-password protected entry into the patient registry). Other acceptance criteria or inclusion criteria may not automatically publish or may be published in a password protected region of the registry.

The registry preferably includes features for encouraging the supply and accumulation of data. The system may optionally include a feature for informing a surgeon that follow-up data is needed. Referring to FIG. 8, the color of the book icon may be green if data is acceptable, and another color (e.g. orange) if follow-up data is needed. Optionally, the system may be include a feature for reminding a surgeon of the need for additional or follow-up information. For example, an e-mail or postcard may be generated if data is less than acceptable.

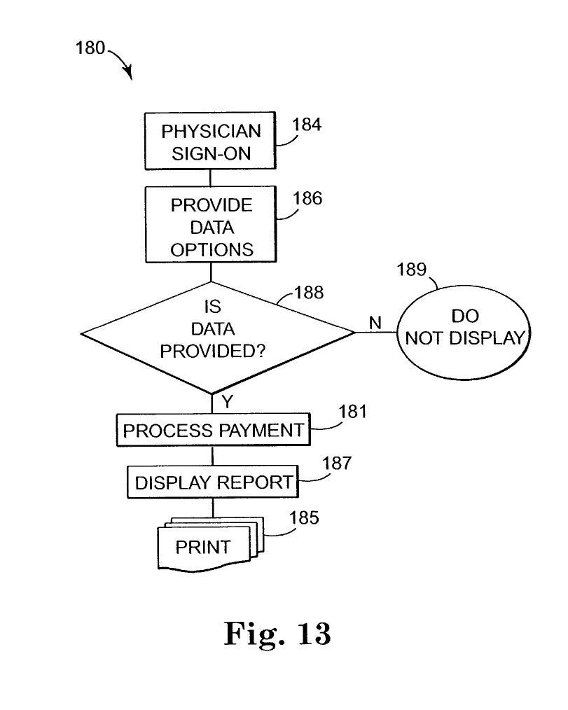

FIG. 13 illustrates a flowchart 180 that may be used to encourage surgeons to supply the data over time. Once the surgeon signs on 184, the surgeon can be given the option of providing full urodynamic type information 186 or other information (e.g. quality of life data). The controller 114 may be programmed to detect which type of information is provided. If a particular type of data is not provided, no output is provided or displayed 189. If the data is detected, a payment may be processed 181, a report optionally displayed 187 and printed 185 if desired. A payment or reminder may also be triggered as described below.

Optionally, the registry allows a healthcare product provider to make a payment in exchange for receiving the information related to the implantation of the sling according to suitable and ethical guidelines (e.g. a payment for time and/or data). An initial payment may be made for initial information and additional payments may be made for follow up data. The amount of the payment may vary according to the type of information provided. For example, urodynamic data may be associated with a larger payment than quality of life data. As an example, a first payment may be made upon receipt of patient history, pre-surgery quality of life information and sling procedure information. A second payment for six month follow-up data with quality of life data. A third payment may be made for twelve month follow-up data with quality of life data. A fourth payment may be made for twenty-four month follow-up data with quality of life data.

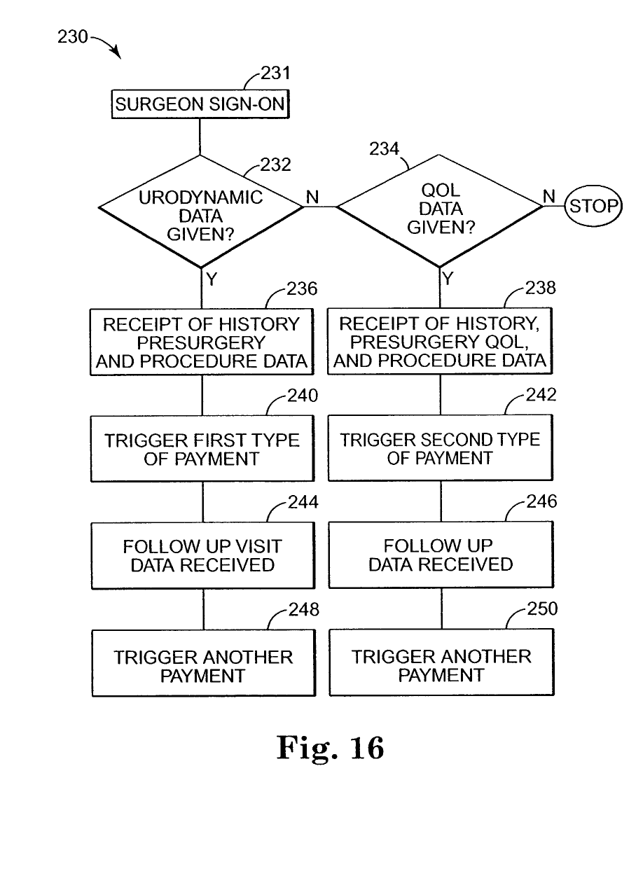

FIG. 16 is a flowchart 130 of one embodiment of payment system according to the present invention. After the surgeon signs on 231, the system determines in step 232 whether urodynamic data is given. If urodynamic data is given, the system can prompt 236 the surgeon for history, presurgery and procedure data. If this data is satisfactorily received, a first type of payment 240 is triggered. The system optionally can be programmed to remind the surgeon that follow up data is needed. Once a follow up data set is received in step 244, the system can trigger another payment in step 248.

The system of FIG. 16 can discriminate between the quality of information provided and tailor payments accordingly. If quality of life data is given in step 234, the system can prompt the surgeon to provide history, presurgery and procedure data in step 238. Once that information is received, a second type of payment may be triggered in step 242. Because the quality of life data may be less expensive to obtain, the second type of payment may be less than the first type of payment. Follow up quality of life data may also be prompted and when received 246, the system can trigger another payment in step 250.

Referring to FIGS. 3a and 8, the present invention may also include a feature for encouraging complete and accurate data accumulation. For example, reference character 39 illustrates one embodiment for signaling required fields to a user of the system. In other embodiment, color coded icons or data may be used to encourage proper data accumulation. For example, the open book icon shown in FIG. 8 may be programmed to turn yellow if the surgeon did not fill out the data entry form (e.g. FIGS. 3a-3d) properly, completely or accurately. As another example, the registry may include a feature for identifying when a report is improperly filled out at the time of filling out the report.

The features for encouraging complete and accurate data accumulation may prevent further use of the registry or a portion thereof. Alternatively the features for encouraging complete and accurate data accumulation may allow further use of the registry and merely signal that the report, data accumulation or other document is insufficient. Payments may optionally be withheld, particularly if the data does not follow a protocol established by the provider of the payment.

The system may also include a feature for informing a user whether a particular protocol is being followed. The protocol may be provided by a medical device provider or it may be customized or tailored for an individual user's (e.g. a surgeon's) requirements.

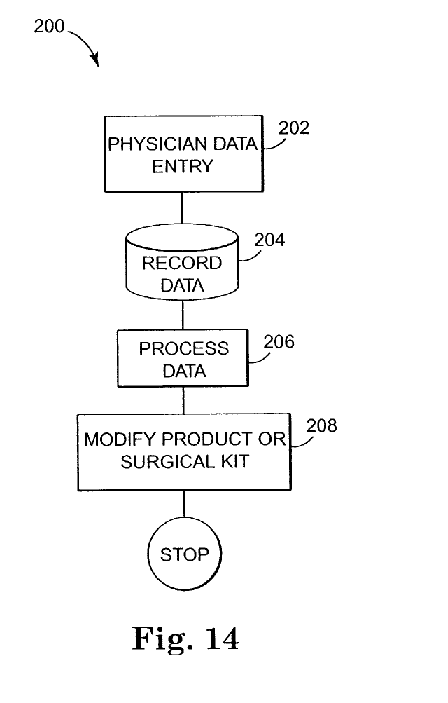

Sling kits and potential components thereof are described in PCT Publication No. WO 02/58564. FIG. 14 is a flowchart 200 showing how the patient registry may be utilized to improve a particular product or the product offering (e.g. the components of a kit) provided by a healthcare provider. Once the physician enters 202, data 204 is recorded. For example, the data may include the data identified in FIGS. 2-7 above. The central controller 114 may be used to sort and analyze the data. For example, it may be determined that, for a particular country, the cystoscopic aids of the SPARC Sling System are unlikely to be used (see FIG. 6, ref. char. 63). In step 208, the provider of the healthcare product (e.g. the SPARC Sling System) may omit the cystoscopic aids for sling kits sold in that country.

As another example, other accessories may also optionally be included in a kit by using the information managed according to the present invention. For example, it may be determined that a surgical drape specifically designed for urological procedures may be needed. Such a drape is disclosed in Published U.S. Pat. Appl. No. 2002/0078964, published Jun. 27, 2002.

In one embodiment, the processing means 114 of the present invention may include a first database that includes a plurality of different treatment regimens, a second database with criteria for evaluating and selecting a therapeutic treatment regimen from the first database, and means for comparing information from a patient to be treated with the first database and the second database. In this embodiment, the registry may be used to display a proposed treatment regimen generated by the processing means. For example, this may be based on pretreatment, clinical, diagnostic and symptomotology of the patient and/or the expertise and/or experience of the physician.

The treatment regimen may be displayed at the preoperative state (recommendations against the use of a particular product or other contraindications), the intraoperative state (e.g. instructions for use of a particular surgical product or kit) or the postoperative state (e.g. instructions for use for a post-operatively adjustable sling).

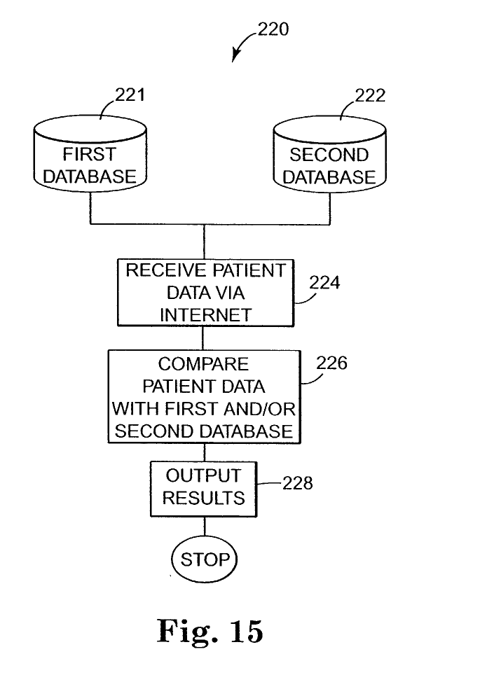

In another embodiment (shown in the flowchart 220 of FIG. 15), the first database 221 may include a plurality of different sling procedures including the SPARC sling procedure, the TVT sling procedure, the Uretex sling procedure, a posterior sling procedure such as the procedure described in U.S. Provisional Application No. 60/380,591, filed May 15, 2002; and a transobturator sling procedure, such as the procedure described in U.S. Provisional Application No. 60/380,797, filed May 14, 2002; No. 60/362,806, filed Mar. 7, 2002 and No. 60/402,007 entitled, “Surgical Articles and Methods”, filed Aug. 8, 2002. The second database 222 may include information relating to the sling procedures (e.g. size of the needles, initial entry and exit points, size of the sling, type of the sling, etc.). In step, 224, the system can receive information concerning the various procedures via the Internet. The computer system (e.g. processor 114 in FIG. 10) may compare a particular patient's data with data within the first or second database. For example, a patient with significant abdominal scarring may not be suitable for the TVT procedure due to a greater likelihood of a particular complication. Alternatively, if the patient has a particular aversion to bladder perforations or a medical reason to avoid such a complication, the system can prompt a surgeon to use a system with a lower likelihood of a bladder perforation than the TVT procedures. The means for comparing information from the first and the second database may be programmed to identify these factors and suggest, e.g. by outputting 228 a message to the surgeon, that a transobturator sling procedure should be considered for this particular patient.

In another embodiment, the first database may include sling tension information (e.g. concerning the tension of the sling), the second database may include options for tightening, loosening or cutting the sling (such as those disclosed in Published U.S. Patent Application No. 2002/0107430A1), and the means for comparing information from the first and second databases may be used to suggest a particular treatment regimen for tightening or loosing the sling (e.g. one of the methods disclosed in Published U.S. Patent Application No. 2002/0107430A1).

In another aspect, the present invention comprises media (e.g. a computer disk) having recorded thereon software which upon installation in a computer and execution of the software will afford use of the computer to carry out the method comprising i) receiving information related to a sling procedure via a network (e.g. the Internet), ii) recording the information in the computer, iii) sorting the information, and iv) outputting results of the sorting. Preferably, the step of sorting the information includes the step of sorting the information into at least one group selected from the groups consisting of patients with a predetermined preexisting condition such as intrinsic sphincter deficiency, patients without a predetermined preexisting condition, patients undergoing concomitant repairs, patients who did not undergo concomitant repairs, patients with urge incontinence, patients without urge incontinence, patients with previous pelvic surgery and patients without previous pelvic surgeries.

Notably, the means for outputting results may comprise personal computer screens, printers, monitors, or the like.

All patents, patent applications, and publications cited herein are hereby incorporated by reference in their entirety as if individually incorporated.

Although the invention has been described in terms of particular embodiments and applications, one of ordinary skill in the art, in light of this teaching, can generate additional embodiments and modifications without departing from the spirit of or exceeding the scope of the invention. Accordingly, it is to be understood that the drawings and descriptions herein are proffered by way of example to facilitate comprehension of the invention and should not be construed to limit the scope thereof.

What is claimed is:

1. A method of managing information useful in pelvic floor repair comprising the steps of:
providing a computer system capable of receiving information via a network, the computer system having processing means for managing the information;
receiving information related to a patient's pelvic floor disorder via the network and recording the information in the computer system,
sorting the information with the processing means, and
outputting results of the sorting.

2. A method according to claim 1 wherein the step of sorting the information with the processing means includes the step of sorting the information into at least one group selected from the groups consisting of patients with a predetermined preexisting condition such as intrinsic sphincter deficiency, patients without a predetermined preexisting condition, patients undergoing concomitant repairs, patients who did not undergo concomitant repairs, patients with urge incontinence, patients without urge incontinence, patients with previous pelvic surgery, and patients without previous pelvic surgeries.

3. A method according to claim 1 further including the step of using the information to alter components of a surgical kit.

4. A method according to claim 1 further including the step of using the information in a publication.

5. A method according to claim 1 wherein the step of providing a computer system includes the step of providing a first database that includes a plurality of different treatment regimens,
providing a second database with criteria for evaluating and selecting a therapeutic treatment regimen from the first database,
the processing means including means for comparing information from a patient to be treated with the first database and the second database,
wherein the step of outputting results of the sorting includes the step of displaying a proposed treatment regimen generated by the processing means.

6. A method according to claim 5 wherein the information received includes information concerning sling tension, and
wherein the step of displaying a proposed treatment regimen includes the step of displaying instructions for loosening or tightening the sling.

7. A method according to claim 1 further including the step of using the information to alter instructions for use of a sling product.

8. A method according to claim 1 wherein the step of receiving information related to a patient's pelvic floor disorder includes the step of receiving urodynamic and cystometry data.

9. A method according to claim 1 wherein the step of receiving information related to a patient's pelvic floor disorder includes the step of receiving quality of life data.

10. A method of managing information relating to surgical sling procedures for treating incontinence comprising the steps of:
identifying a surgical sling procedure including the implantable sling material, the surgical articles used during procedure and the instructions for use, and recording the information relating to the surgical sling procedure in a database,
recording complications exhibited by a patient after a surgical sling procedure via a network, and
identifying measurable sources of complications associated with the surgical sling procedure.

11. A method according to claim 10 wherein the step of identifying measurable sources of complications associated with the surgical sling procedure includes the step of identifying measurable sources of a complication associated with a particular implantable sling material, and
the method includes the step of outputting the results identifying a complication with a particular implantable sling material.

12. A method of managing information useful in treating incontinence comprising the steps of:
providing a computer system capable of receiving information via a network,
receiving information related to implantation of a sling on a patient via the network and recording the information in the computer system, and
making a payment in exchange for receiving the information related to the implantation of the sling.

13. A method according to claim 12 wherein the step of receiving information related to implantation of the sling product includes the steps of receiving initial patient information and then subsequently receiving follow up patient information collected at a predetermined time following the implantation of the sling.

14. A method according to claim 13 wherein the step of making a payment in exchange for receiving the information includes the step of making an additional payment after receipt of the initial patient information and making a second payment after receipt of follow up patient information.

15. Media having recorded thereon software which upon installation in a computer and execution of the software will afford use of the computer to carry out the method comprising:
receiving information related to a sling procedure via a network,
recording the information in the computer,
sorting the information, and
outputting results of the sorting.

16. Media according to claim 15 wherein the step of sorting the information includes the step of sorting the information into at least one group selected from the groups consisting of patients with a predetermined preexisting condition such as intrinsic sphincter deficiency, patients without a predetermined preexisting condition, patients undergoing concomitant repairs, patients who did not undergo concomitant repairs, patients with urge incontinence, patients without urge incontinence, patients with previous pelvic surgery and patients without previous pelvic surgeries.

17. A computer system for managing information useful in pelvic floor repair comprising:
means receiving information related to pelvic floor repair via a network,
processing means for managing the information including recording means for recording the information and sorting means for sorting the information with the processing means, and
means for outputting results of the sorting means.

18. A computer system according to claim 17 wherein the means for outputting results of the sorting means include means for displaying results via a network connection.

19. A computer system according to claim 17 wherein the processing means includes means for triggering a payment in exchange for receiving the information related to the implantation of the sling.

20. A computer system according to claim 17 wherein the sorting means for sorting the information includes means for sorting the information into at least one group selected from the groups consisting of patients with a predetermined preexisting condition such as intrinsic sphincter deficiency, patients without a predetermined preexisting condition, patients undergoing concomitant repairs, patients who did not undergo concomitant repairs, patients with urge incontinence, patients without urge incontinence, patients with previous pelvic surgery, and patients without previous pelvic surgeries.
